(19) United States
(12) Patent Application Publication
(10) Pub. No.: US 2025/0367812 A1
(43) Pub. Date: Dec. 4, 2025

(54) Driving Tool with Bit Storage

(71) Applicant: Milwaukee Electric Tool Corporation, Brookfield, WI (US)

(72) Inventor: Lucas M. Schmidt, Eagle, WI (US)

(21) Appl. No.: 19/187,584

(22) Filed: Apr. 23, 2025

Related U.S. Application Data
(60) Provisional application No. 63/655,837, filed on Jun. 4, 2024.
(60) Provisional application No. 63/675,031, filed on Jul. 24, 2024.

(51) Int. Cl. B25G 1/08; B25B 23/00

(52) U.S. Cl. CPC B25G 1/085; B25B 23/0035; B25B 23/0042

(57) ABSTRACT

Various embodiments of a driving tool with bit storage are provided. In a specific embodiment, the driving tool includes a handle, a shaft, and a socket. The shaft is centered on and extends along a longitudinal axis. The shaft includes a flange extending away from an external surface of the shaft. The flange includes a first step extending circumferentially around the longitudinal axis, and the first step defines a first radius. The flange further includes a second step extending circumferentially around the longitudinal axis, and the second step defines a second radius different from the first radius. The socket includes a first end configured to engaged with the first step such that the first step defines a first effective depth of the socket.

### CROSS-REFERENCE TO RELATED PATENT APPLICATIONS

The present application claims the benefit of and priority to U.S. Provisional Application No. 63/675,031, filed Jul. 24, 2024, and U.S. Provisional Application No. 63/655,837, filed Jun. 4, 2024, which are incorporated herein by reference in their entireties.

### BACKGROUND OF THE INVENTION

The present invention relates generally to the field of tools. The present invention relates specifically to a driving tool, such as a nut driver, screwdriver, etc., that includes storage for one or more engagement bits, such as nut driving sockets, screwdriver bits, etc., along the shank of the driving tool and/or within the handle of the driving tool.

### SUMMARY OF THE INVENTION

One embodiment of the invention relates to a driving tool. The driving tool includes a handle, a shaft, and a first socket. The shaft is centered on and extends along a longitudinal axis. The shaft includes a mounting end, a second end opposite the mounting end, and a flange. The second end is coupled to a first end of the handle. The flange extends away from an external surface of the shaft between the mounting end and the second end. The flange includes a first step and a second step. The first step extends circumferentially around the longitudinal axis. The first step defines a first radius. The second step extends circumferentially around the longitudinal axis, and the second step defines a second radius different from the first radius. The first socket includes a first engagement end and a second engagement end. The first engagement end of the first socket is configured to engage with the first step such that the first step defines a first effective depth of the first socket.

Another embodiment of the invention relates to a driving tool including a handle, a shaft, a first socket, and a second socket. The handle is centered on and extends along a longitudinal axis. The handle includes a first end and a second end opposite the first end along the longitudinal axis. The shaft is removably coupled to the first end of the handle. The shaft is centered on and extends along the longitudinal axis. The shaft includes a mounting end, a second end opposite the mounting end along the longitudinal axis, a first step, and a second step. The second end of the shaft is coupled to the first end of the handle. The first step is positioned along the shaft between the mounting end and the second end of the shaft. The first step extends circumferentially around the longitudinal axis. The first step extends away from a top surface of the second step towards the mounting end. The second step extends circumferentially around the longitudinal axis. The first socket includes a first engagement end defining a first circumference. The first engagement end of the first socket is configured to engage with the first step such that the first step defines a first effective depth of the first socket. The second socket includes a second engagement end defining a second circumference greater than the first circumference. The second engagement end of the second socket is configured to engage with the second step such that the second step defines a second effective depth of the second socket.

Another embodiment of the invention relates to a driving tool. The driving tool includes a handle, and end cap, and an engagement bit. The handle is centered on and extends along a longitudinal axis. The handle includes a first end, a second end opposite the first end along the longitudinal axis, and a body extending between the first end and the second end. The body defines a cavity. An outer surface of the body circumferentially surrounded the cavity with respect to the longitudinal axis. The end cap is configured to removably couple to the second end of the handle. The end cap includes a base and a shank extending away from the base. The engagement bit includes a central opening. The engagement bit mounted on the shank of the end cap. When the end cap is coupled to the second end of the handle, the shank extends away from the base within the cavity and towards the first end of the handle, and the engagement bit is retained within the cavity along the shank.

Additional features and advantages will be set forth in the detailed description which follows and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a driving tool, according to an exemplary embodiment;

FIG. 2 is a side cross-sectional view of the driving tool of FIG. 1, according to an exemplary embodiment;

FIG. 3 is a detailed cross-sectional view of the handle of the driving tool of FIG. 1, according to an exemplary embodiment;

FIG. 4 is a side view of a driving tool and sockets, according to another exemplary embodiment;

FIG. 5 is a detailed side view of the shaft of the driving tool of FIG. 4, according to an exemplary embodiment;

FIG. 6 is a detailed view of the mounting end of the shaft of the driving tool of FIG. 4, according to an exemplary embodiment;

FIG. 7 is a detailed view of the sockets of the driving tool of FIG. 4, according to an exemplary embodiment;

FIG. 8 is a cross-sectional view of a socket on the shaft of the driving tool of FIG. 4, according to an exemplary embodiment;

FIG. 9 is a perspective view of a shaft for a driving tool such as the driving tool of FIG. 1 or FIG. 4, according to an exemplary embodiment;

FIG. 10 is a side cross-sectional view of sockets mounted on the shaft of FIG. 9 and positioned within a cavity of a driving tool, such as the driving tool of FIG. 1, according to an exemplary embodiment;

FIG. 11 is a side view of a driving tool, according to another exemplary embodiment;

FIG. 12 is a detailed view of the shaft and engagement bit mounted on the handle of the driving tool of FIG. 11, according to an exemplary embodiment;

FIG. 13 is a detailed view of the sliding handle of the driving tool of FIG. 11 with the spring band shown in broken lines, according to an exemplary embodiment;

FIG. 14 is a detailed view of the spring band of the driving tool of FIG. 11, with an end of the shaft shown in broken lines, according to an exemplary embodiment;

FIG. 15 is a detailed view of shaft and engagement bits of the driving tool of FIG. 11, according to an exemplary embodiment;

FIG. 16 is a detailed view of the double-ended engagement bits of the driving tool of FIG. 11, according to an exemplary embodiment;

FIG. 17 is a perspective view of a driving tool, according to another exemplary embodiment;

FIG. 18 is detailed view of the shaft, engagement bit, and collar of the driving tool of FIG. 17, with the handle shown in dot-dash lines, according to an exemplary embodiment;

FIG. 19 is a side view of the shaft, engagement bit, and collar of the driving tool of FIG. 17, according to an exemplary embodiment;

FIG. 20 is a side view of the shaft and engagement bits of the driving tool of FIG. 17, according to an exemplary embodiment;

FIG. 21 is a detailed view of the front of the driving tool of FIG. 17 in the locked position, according to an exemplary embodiment;

FIG. 22 is a side cross-sectional view of the front end of the driving tool of FIG. 17, according to an exemplary embodiment;

FIG. 23 is a detailed view of the channels in the handle of the driving tool of FIG. 17, according to an exemplary embodiment;

FIG. 24 is a view of the driving tool of FIG. 17 in the unlocked position, according to an exemplary embodiment;

FIG. 25 is a view of the driving tool of FIG. 17 in the locked position, according to an exemplary embodiment;

FIG. 26 is a perspective view of a driving tool, according to another exemplary embodiment;

FIG. 27 is an exploded view of the driving tool of FIG. 26, according to an exemplary embodiment;

FIG. 28 is a detailed view of the handle of the driving tool of FIG. 26, with the engagement bits stored within eh cavity of the driving tool shown in broken lines, according to an exemplary embodiment;

FIG. 29 is a cross-sectional view of the handle of the driving tool of FIG. 26, according to an exemplary embodiment; and

FIG. 30 is a detailed view of the end cap and engagement bits of the driving tool of FIG. 26, according to an exemplary embodiment.

### DETAILED DESCRIPTION

Referring generally to the figures, various embodiments of a driving tool with storage for one or more engagement bits along the handle and/or shank of the driving tool are shown. Applicant believes that the driving tools discussed herein provide various advantages over typical driving tools.

Specifically, various driving tools discussed herein include a cavity formed in the handle and an end cap with a support shank retained within the cavity when the end cap is coupled to the handle. Engagement bits, such as sockets with a central opening, are mounted on the support shank and can be retained within the cavity when the end cap is coupled to the handle. Applicant believes that this configuration provides for convenient storage of bits, as well as easier access to engagement bits, because a user can access or store the desired bit by disengaging and reengaging the end cap.

In addition, various embodiments discussed herein include a shaft of a driving tool with a plurality of steps located at a mounting end of the shaft. These steps are each configured to engage a different sized socket. Applicant believes this configuration allows for mounting a variety of different sized sockets, while also setting an effective depth for the different sized sockets.

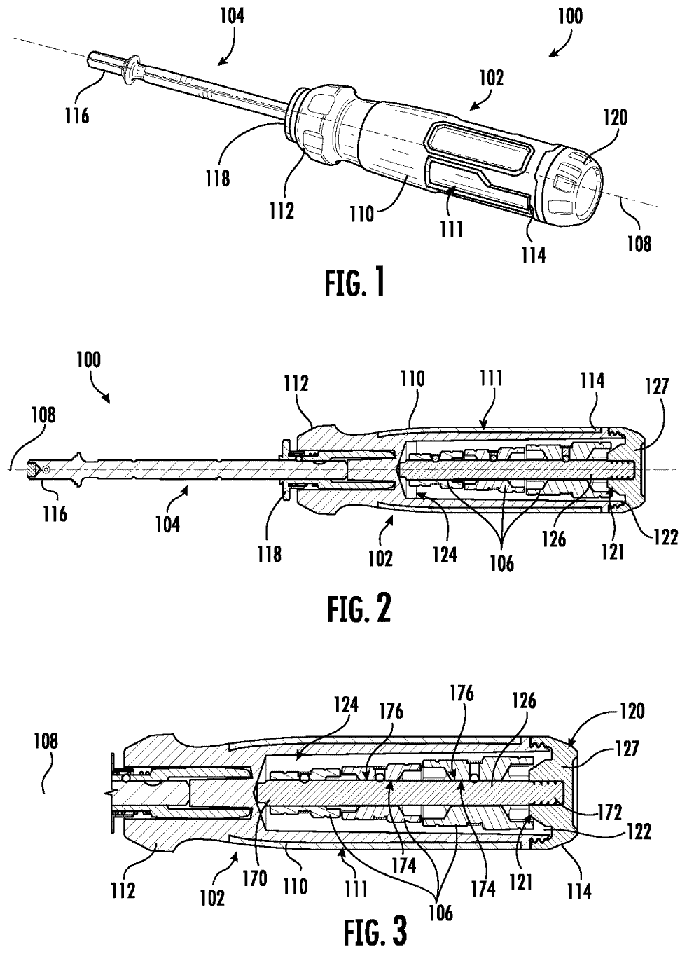

Referring to FIGS. 1-3, a driving tool 100, such as a nut driver, screwdriver, etc. is shown and described. Driving tool 100 includes a handle 102 and a shaft 104. Shaft 104 is coupled to handle 102 and configured to engage an engagement bit, such as screwdriver bits, drill bits, sockets etc. In the specific embodiment shown, driving tool 100 is a nut driver and the engagement bits are sockets 106. More specifically, sockets 106 are reversible sockets which include different sized socket engagement surfaces at opposite ends of socket 106. Sockets 106 each include a central opening at each end of the respective socket 106.

Driving tool 100 includes a longitudinal axis 108. Handle 102 is centered on and extends along longitudinal axis 108. Handle 102 has a body 110 with a first end 112 and a second end 114 opposite the first end 112 with respect to longitudinal axis 108. Body 110 has an outer surface 111.

Shaft 104 is configured to removably couple to handle 102 at first end 112. When coupled to handle 102, shaft 104 is centered on and extends along the longitudinal axis 108. In particular, shaft 104 extends in a direction away from first end 112 and away from second end 114 along longitudinal axis 108.

Shaft 104 has a first end or mounting end 116 configured to receive sockets 106 and a second end 118 located opposite from mounting end 116. Second end 118 of shaft 104 is configured to couple to handle 102 at first end 112 of body 110. As shown, second end 118 of shaft 104 is removably coupled to handle 102 at first end 112. In various embodiments, shaft 104 may be fixedly coupled to handle 102, or shaft 104 may be formed from as a single contiguous, continuous piece of material with handle 102.

Driving tool 100 includes an end cap 120 coupled to handle 102 at second end 114. End cap 120 is configured to removably couple to handle 102. As shown in FIGS. 2-3, end cap 120 is mounted to handle 102 via threading. End cap 120 includes a includes a threaded inner surface configured to engage with a threaded portion 122 of outer surface 111 adjacent to second end 114. In various embodiments, end cap 120 may be coupled to handle 102 via internal threading located at second end of handle 102 and external threading on end cap 120. In other various embodiments, end cap 120 may be coupled to handle 102 via an interference fit, such as a friction fit, press fit, or snap fit.

Referring to FIGS. 2-3, body 110 of handle 102 defines a cavity 124. M ore specifically, outer surface 111 of body 110 defines cavity 124 between first end 112 and second end 114. Cavity 124 is centered on and extends along longitudinal axis 108 between first end 112 and second end 114. Outer surface 111 circumferentially surrounds cavity 124 with respect to longitudinal axis 108. An opening 121 defined in second end 114 of handle 102 provides access to cavity 124. End cap 120 may extend through opening 121 into cavity 124.

End cap 120 includes a support shaft or support shank 126 and a base 127. Support shank 126 is coupled to base 127 and extends away from base 127. Support shank 126 includes a receiving end 170 and an attachment end 172 opposite receiving end 170. Attachment end 172 is configured to removably couple to base 127. When end cap 120 is coupled to handle 102, support shank 126 is centered on and extends along longitudinal axis 108. When end cap 120 is coupled to handle 102, support shank 126 extends away from base 127, away from second end 114 of body 110 of handle 102, and towards first end 112 in a direction along longitudinal axis 108. When end cap 120 is coupled to handle 102 at second end 114, support shank 126 extends through opening 121 and is retained within cavity 124. As shown, support shank 126 is removably coupled to base 127 of end cap 120 via threading. In various embodiments, support shank 126 may be formed from single contiguous, continuous piece of material with base 127. In other various embodiments, support shank 126 may be coupled to base 127 via an interference fit, such as a friction fit, press fit, or a snap fit.

Sockets 106 are configured to be mounted on mounting end 116 of shaft 104. Additionally, sockets 106 are configured to be mounted on support shank 126 and stored within cavity 124 when sockets 106 are not in use. In particular, sockets 106 are mounted on shank 126 between receiving end 170 and attachment end 172. When mounted on shank 126, an inner surface 174 of each of the sockets 106 interfaces with an external surface 176 of shank 126. As shown, at least one socket 106 is mounted on support shank 126 and retained within cavity 124. Specifically, three sockets 106 are shown mounted on support shank 126 and retained within cavity 124. In various embodiments, sockets 106 are retained on support shank through snaps, ball detents, magnets, or other retention mechanisms.

When mounted on support shank 126 and positioned within cavity 124, sockets 106 are centered on longitudinal axis 108 and are surrounded by outer surface 111 of body 110 with respect to longitudinal axis 108. To access a socket 106, a user removes end cap 120 from handle 102. The user may then select the desired socket 106 from support shank 126 and mount the socket 106 on mounting end 116 of shaft 104.

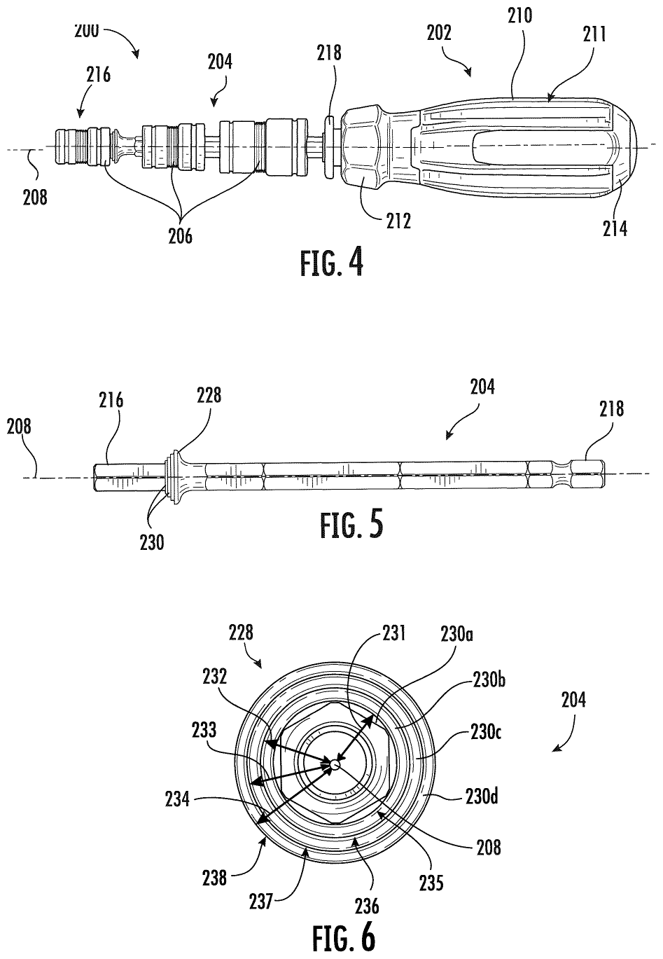

Referring to FIGS. 4-9, a driving tool 200 is shown. Driving tool 200 is substantially the same as driving tool 100, except for the differences discussed herein. Specifically, a shaft 204 of driving tool 200 is configured to receive and retain engagement bits, shown as sockets 206. Shaft 204 includes a plurality of steps 230. Each step 230 is configured to receive and retain a different sized socket 206 and set the effective depth for the corresponding socket 206.

Referring to FIG. 4, driving tool 200 includes a handle 202 and shaft 204. Handle 202 has a body 210 that is centered on and extends along a longitudinal axis 208. Body 210 has a first end 212 and a second end 214 opposite the first end 212 with respect to the longitudinal axis 208. Shaft 204 is configured to be removably coupled to handle 202 at first end 212. When coupled to handle 202, shaft 204 is centered on and extends along longitudinal axis 208. Shaft 204 has a first end or mounting end 216 configured to receive sockets 206 and a second end 218 located opposite from mounting end 216. Second end 218 of shaft 204 is removably coupled to first end 212 of handle 202. Sockets 206 are configured to engage mounting end 216 of shaft 204.

As shown, when sockets 206 are not engaged with mounting end 216, sockets 206 may be stored along the length of shaft 204 between mounting end 216 and second end 218. In various embodiments, sockets 206 are retained on shaft 204 between mounting end 216 and second end 218 through snaps, ball detents, magnets, or other retention mechanisms. To access a socket 206, a user removes shaft 204 from handle 202. The user may then select the desired socket 206 and mount the socket 206 on mounting end 216 of shaft 204.

Referring to FIGS. 5 and 6, shaft 204 is shown in more detail. Mounting end 216 of shaft 204 is shaped to receive and retain sockets 206. As shown, shaft 204 includes a flange 228 located proximate to mounting end 216. Flange 228 is located a first distance from mounting end 216 that is less than a second distance that flange 228 is spaced from second end 218 such that flange 228 is located closer to mounting end 216 than second end 218. Flange 228 extends away from an external surface 276 of shaft 204. Flange 228 is configured to stop sockets 206 from sliding or moving along shaft 204 towards second end 218, when sockets are mounted on mounting end 216. Flange is spaced a distance from mounting end 216 to allow for sockets 206 to be inserted onto or slide into secure engagement with shaft 204 at mounting end 216. In a specific embodiment, flange 228 is formed from a single contiguous, continuous piece of material with shaft 204.

Shaft 204 further includes plurality of steps 230. Plurality of steps 230 are coupled to shaft 204 proximate to mounting end 216. Specifically, flange 228 includes the plurality of steps 230. Plurality of steps 230 are formed on flange 228. Each step in the plurality of steps 230 is centered along shaft 204 and is centered on longitudinal axis 208. Each step 230 in the plurality of steps extends circumferentially around longitudinal axis. As shown, each step in the plurality of steps 230 is circular shaped and defines a radius. As shown, the further a step 230 is spaced from mounting end 216, the greater the radius of the respective step 230. Plurality of steps 230 are configured to engage a different sized sockets 206. Steps 230 set the effective depth of sockets 206 when sockets 206 are mounted on shaft 204 at mounting end 216. The effective depth is the depth at which a workpiece, such as a fastener (e.g., bolts, nuts, and screws etc.) abuts an engagement surface of a socket 206. That is, the effective depth is the distance 250 that a workpiece extends into socket 206.

As shown in FIGS. 5, 6 and 8, shaft 204 includes four steps 230a, 230b, 230c, 230d. First step 230a circumferentially surrounds longitudinal axis 208 and defines a first radius 231 measured from longitudinal axis 208 to an outer edge 235 of step 230a. Second step 230b circumferentially surrounds longitudinal axis 208 and defines a second radius 232 measured from longitudinal axis 208 to an outer edge 236 of step 230b. Second radius 232 is different from first radius 231. Specifically, second radius 232 is greater than first radius 231. That is, first radius 231 is less than second radius 232. Second step 230b is spaced further from mounting end 216 than first step 230a. First step 230a extends away from a top surface of second step 230b towards mounting end 216.

Third step 230c circumferentially surrounds longitudinal axis 208 and defines a third radius 233 measured from longitudinal axis 208 to an outer edge 237 of step 230c. Third radius 233 is different from first radius 231 and second radius 232. Third radius 233 is greater than first radius 231 and second radius 232. Third step 230c is spaced further from mounting end 216 than first step 230a and second step 230b. Second step 230b is positioned between first step 230a and third step 230c. Specifically, second step 230b extends away from a top surface of third step 230b towards mounting end 216.

Fourth step 230d circumferentially surrounds longitudinal axis 208 and defines a fourth radius 234 measured from longitudinal axis 208 to an outer edge 238 of step 230d. Fourth radius 234 is greater than first radius 231, second radius 232, and third radius 233. Fourth step 230d is spaced further from mounting end 216 than first step 230a, second step 230b, and third step 230c. Third step 230c is positioned between second step 230b and fourth step 230d. Specifically, third step 230c extends away from a top surface of fourth step 230d towards mounting end 216.

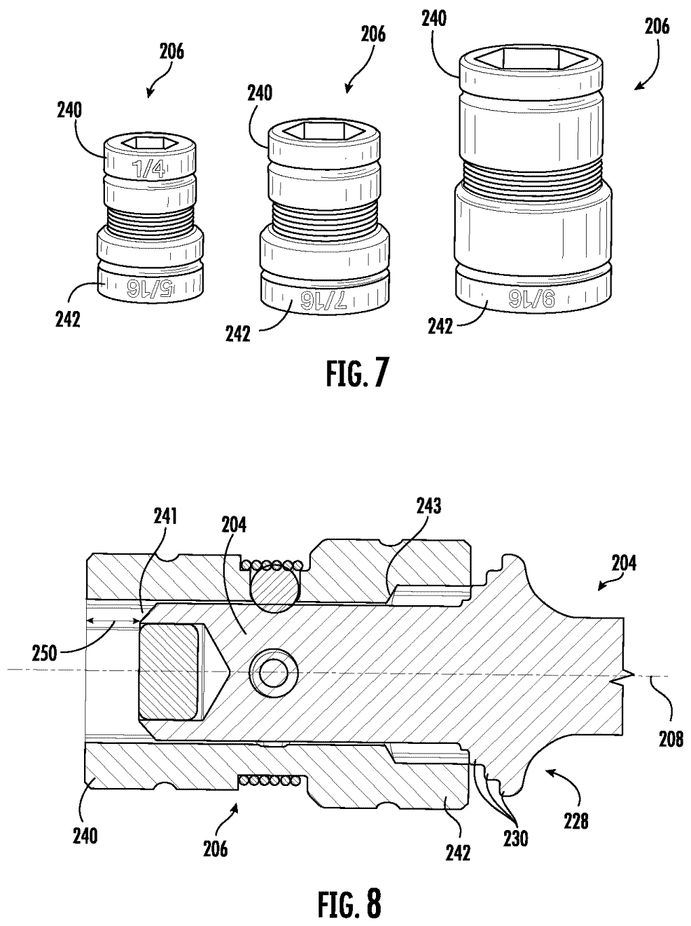

Referring to FIGS. 7 and 8, as shown, sockets 206 are generally cylinder shaped with hexagonal openings for receiving workpieces, such as fasteners (e.g., bolts, nuts, and screws etc.), or shaft 204. However, sockets 206 may be a variety of shapes (circular, hexagonal, square, rectangular, etc.) and sizes (¼ inch, ⅜ inch, etc.). Each socket 206 includes a first engagement end or first end 240 with a first engagement surface 241, and a second engagement end or second end 242 with a second engagement surface 243. As shown, first end 240 and second end 242 are different sizes. In particular, first end 240 defines a first circumference different from a second circumference defined by the second end 242. As shown, first circumference is less than second circumference. In this way, first end 240 is configured to receive a different sized workpiece than second end 242. In various embodiments, first end 240 and second end 242 are configured to engage with different steps 230 such that first end 240 and second end 242 have different effective depths. In a specific embodiment, first end 240 is configured to engage with a first step 230 such that the first step 230 defines a first effective depth of socket 206, and second end 242 is configured to engage with a second step 230 such that the second step 230 defines a second effective depth of socket 206. As shown, sockets 206 are a ¼ inch and 5/16 inch reversible socket, a ⅜ inch and 7/16 inch reversible socket, and are a ½ inch and 9/16 inch reversible socket.

Referring to FIG. 8, the effective depth of socket 206 is distance 250 measured between first end 240 and first engagement surface 241. In this way, the effective depth is the distance 250 that a workpiece may extend into socket 206 from first end 240 towards second end 242 before abutting first engagement surface 241.

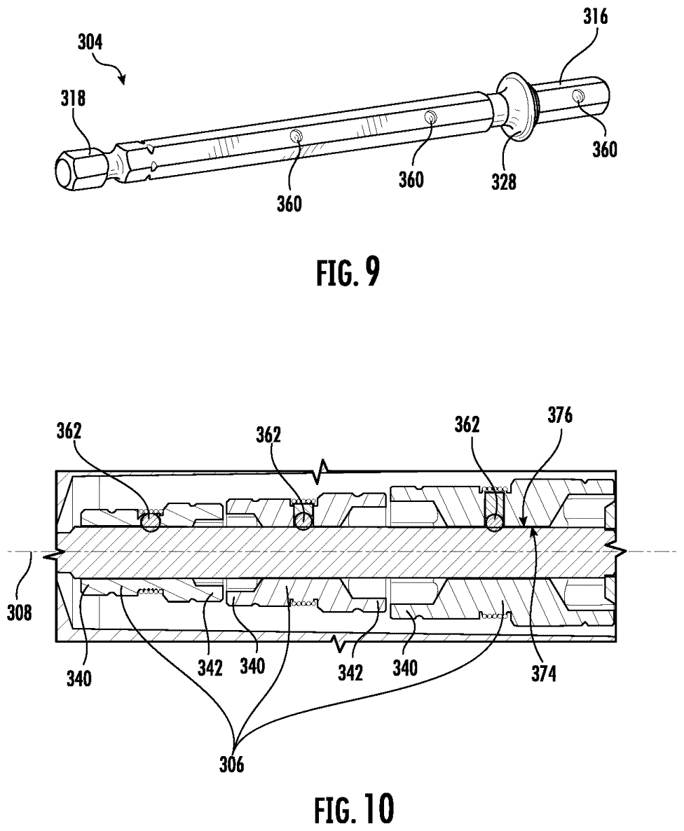

Referring to FIGS. 9 and 10, a shaft 304 and sockets 306 for a driving tool, such as driving tools 100 and 200 are shown. Shaft 304 is substantially the same as shafts 104 and 204, except for the differences discussed herein. Sockets 306 are substantially the same as sockets 106 and 206, except for the differences discussed herein. Specifically, shaft 304 includes recesses 360 configured to engage with projections 362 on sockets 306 in order to retain sockets 306 along shaft 304. As shown, projections 362 are ball detents.

As shown in FIG. 9, two recesses 360 are formed along an external surface 376 of shaft 304 between a flange 328 and a second end 318. These recesses 360 are configured for retaining socket 306 between mounting end 316 and second end 318, when not mounted on mounting end 316. Another recess 360 is formed adjacent to mounting end 316 between flange 328 and mounting end 316 and is configured to retain socket 306 on mounting end 316.

As shown in FIG. 10, each socket 306 includes a projection 362 between a first end 340 and a second end 342 of socket 306. Projections 362 are configured to retain sockets 306 on shaft 304. Additionally, projections 362 and recesses 360 assist in positioning sockets 306 along shaft 304. In various embodiments, a support shank, like support shank 126, may include recesses to retain sockets on the support shank similar to shaft 304.

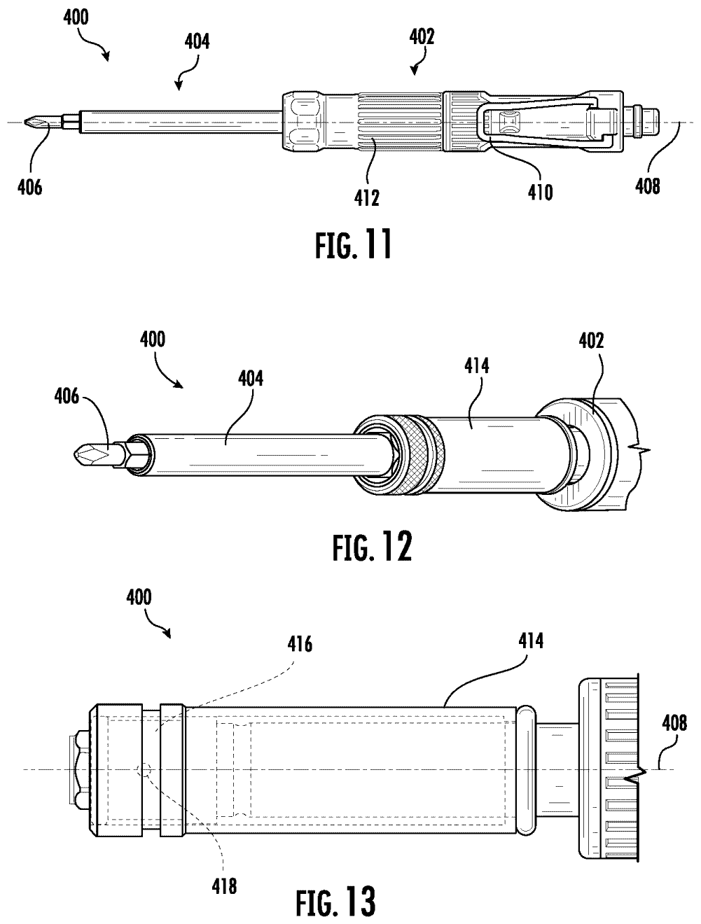

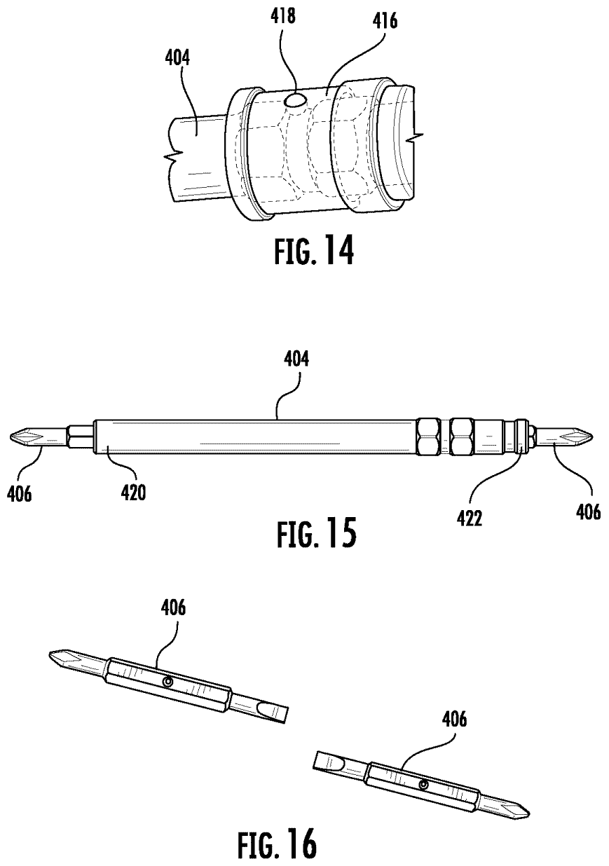

Referring to FIGS. 11-16, a driving tool such as screwdriver 400 is shown. Screwdriver 400 is believed to provide benefits over other screwdrivers by having greater versatility, as well as providing a sliding handle 402 to secure engagement bits, such as screwdriver bits 406, within handle 402 during non-use.

Referring to FIGS. 11-14, screwdriver 400 has handle 402 and a shaft 404. Handle 402 is centered on and extends along a longitudinal axis 408. Shaft 404 is configured to removably couple to handle 402. When coupled to handle 402, shaft 404 is centered on and extends along longitudinal axis 408. A deformable wire clip 410 is coupled to handle 402. Deformable wire clip 410 is configured to be worn by a user, such as on a belt or in a pocket. At least a first portion 412 of handle 402 is slidable along shaft 404 with respect to longitudinal axis 408.

First portion 412 of handle 402 includes a collar 414 configured to slide along shaft 404. In a specific embodiment, collar is made of aluminum. Collar 414 can receive and retain bit 406 when collar 414 is slid into position around bit 406. A spring band 416 is positioned within collar 414. Spring band 416 is configured to hold shaft 404 in engagement with handle 402 while, first portion of handle 402 and collar 414 slide along shaft 404. Spring band 416 includes a ball detent 418, which engages with shaft 404 such that shaft 404 is retained.

Referring to FIGS. 15-16, shaft 404 and bits 406 are shown. Shaft 404 has a first end 420 configured to receive and retain a first bit 406, and a second end 422 opposite the first end 420 configured to receive and retain a second bit 406. Bits 406 are double-ended such that they are configured to engage with two different sized and/or shaped workpieces. By being stored in shaft 404 the bits are more easily exchanged based on a user's needs.

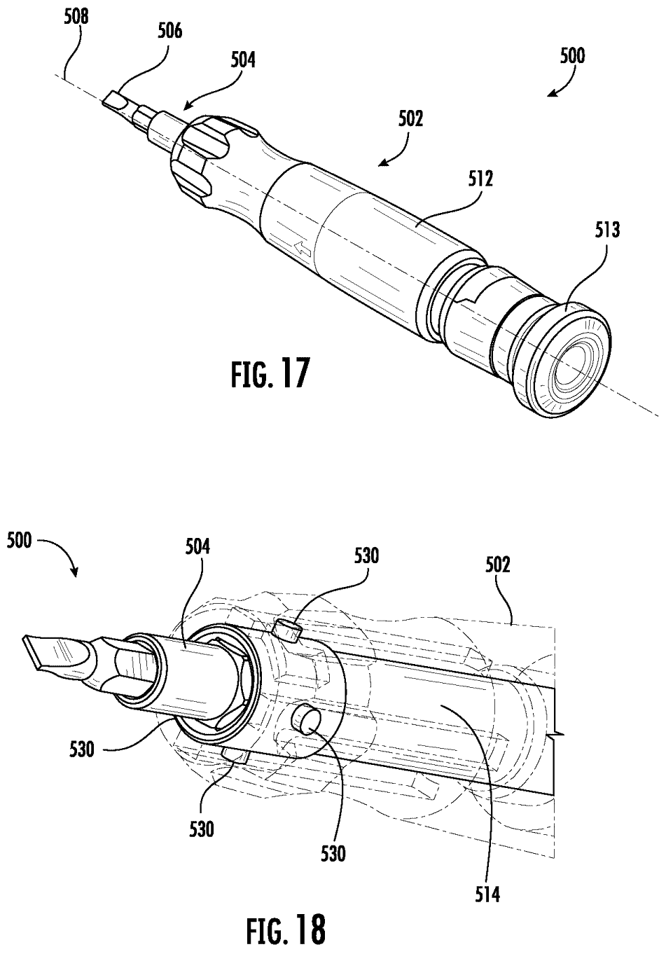

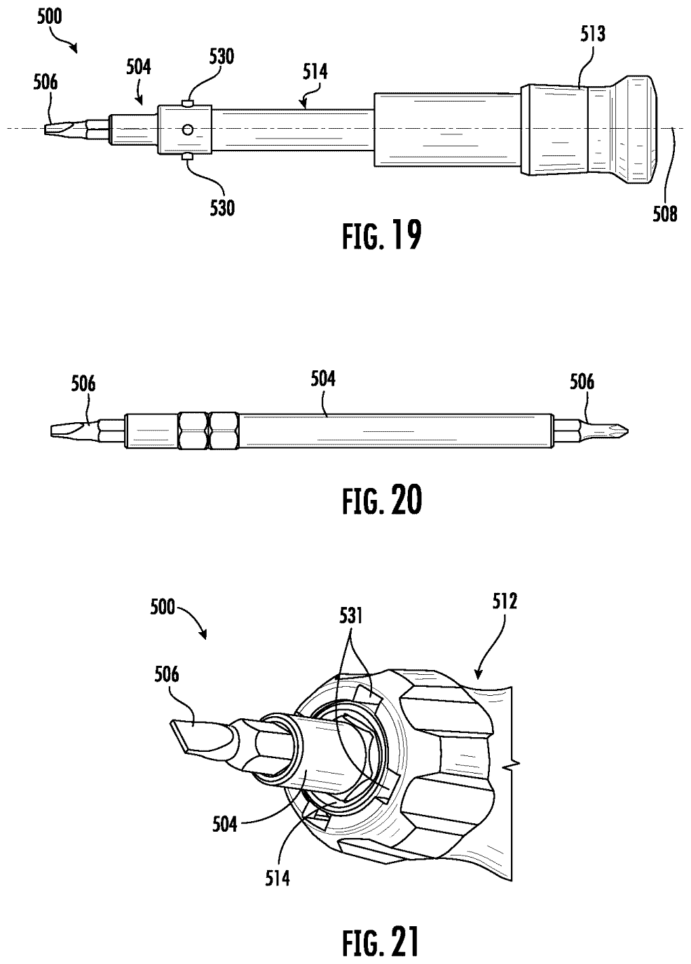

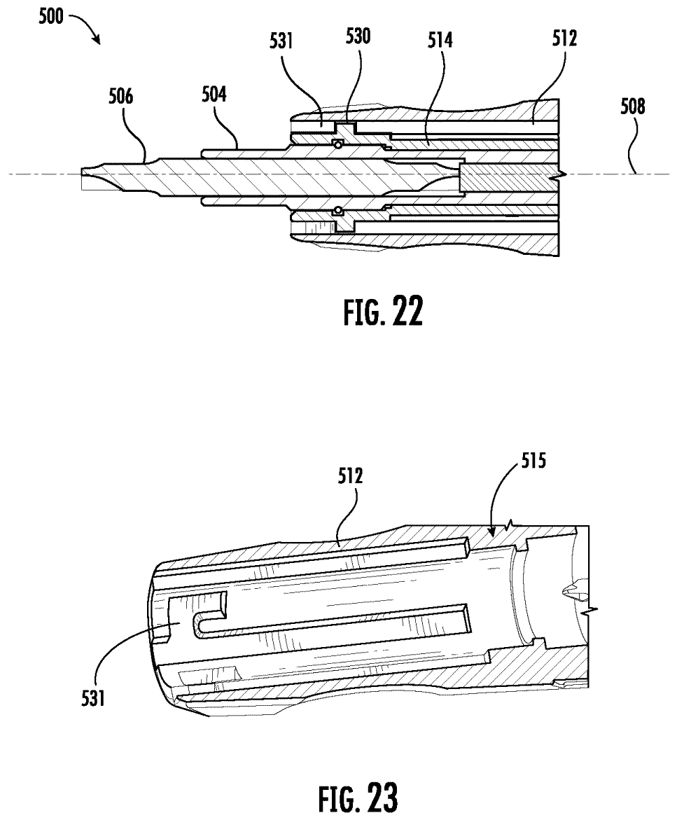

Referring to FIGS. 17-25, a driving tool such as screwdriver 500 is shown. Screwdriver 500 is substantially the same as screwdriver 400, except for the differences discussed herein. In particular, a handle 502 configured to move a shaft 504 between and locked and unlocked position. When in the locked position, an engagement bit, such as screwdriver bit 506 extends from handle 502 of screwdriver 500. When in the unlocked position, bit 506 is retracted and stored within handle 502. Applicant believes that screwdriver 500 provides benefits over other screwdrivers by having greater versatility, as well as providing a retractable engagement bit such that bit 506 can be quickly stored within handle 502 during non-use.

Referring to FIGS. 17-23, screwdriver 500 has handle 502 and a shaft 504. Handle 502 is centered on and extends along a longitudinal axis 508. Shaft 504 is configured to removably couple to handle 502. Bits 506 are mounted on shaft 504. At least a first portion 512 of handle 502 is slidable along shaft 504 with respect to longitudinal axis 508. A second portion 513 of handle 502 is rotatable around longitudinal axis 508 and can rotate with respect to first portion 512. Second portion 513 is configured to actuate screwdriver 500 between a locked and unlocked position.

Screwdriver 500 includes a collar 514. Shaft 504 is removably coupled to collar 514. Collar 514 includes locking lugs or projections 530. As shown, collar 514 has four projections 530. Projections 530 are configured to engage with first portion 512 of handle 502. Specifically, first portion 512 of handle 502 includes channels 531. Channels 531 are formed on an inner wall 515 of first portion 512 of handle 502. Projections 530 are configured to travel along channels 531. Channels 531 are configured to receive and retain projection 530. In various embodiments, projections 530 may be positioned along inner wall 515, and channels 531 are formed on collar 514.

When screwdriver 500 is actuated into the locked position, projections 530 are retained in channels 531 such that projections 530 are restricted from moving in a direction parallel to longitudinal axis 508. When in the unlocked position, projections 530 can freely slide along channels 531 in a direction parallel to longitudinal axis 508. A user can actuate screwdriver 500 between the locked and unlocked positions by rotating second section 513 of handle 502 around longitudinal axis.

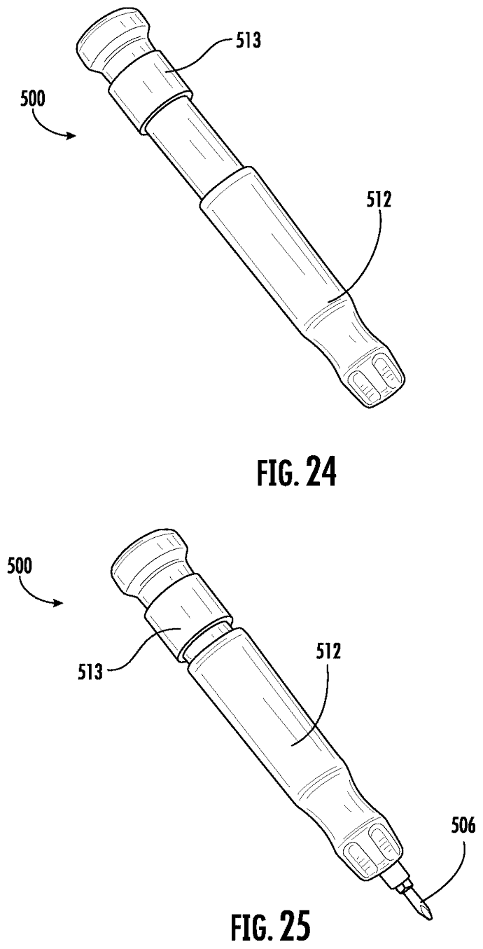

Referring to FIGS. 24, screwdriver 500 is shown in the unlocked position. When in the unlocked position, the first portion of handle 502 is able to slide into position around bit 506.

Referring to FIG. 25, screwdriver 500 is shown in the locked position. When in the locked position, first portion 512 of handle 502 abuts the second portion 513 of handle 502, and bit 506 extends away from handle 502 along longitudinal axis 508.

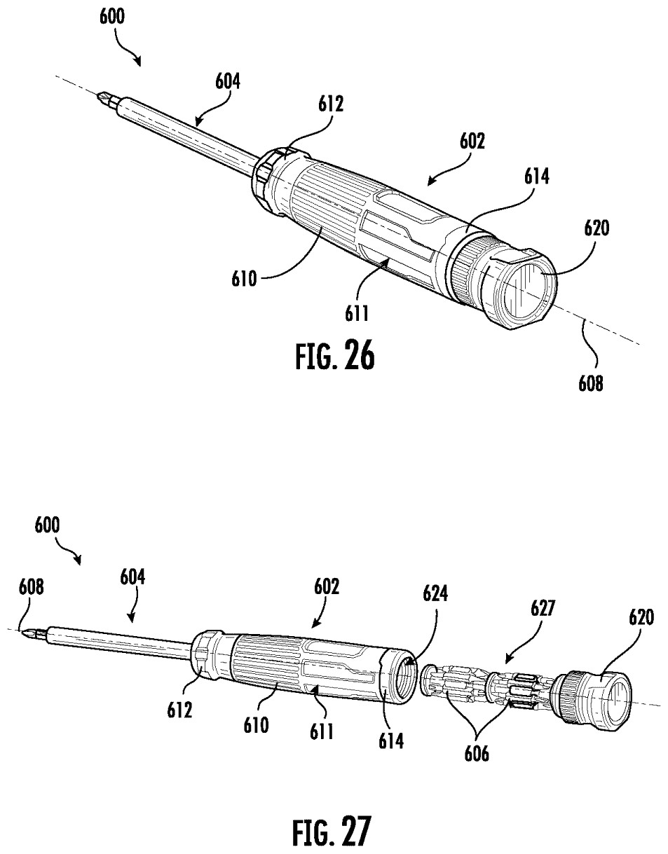

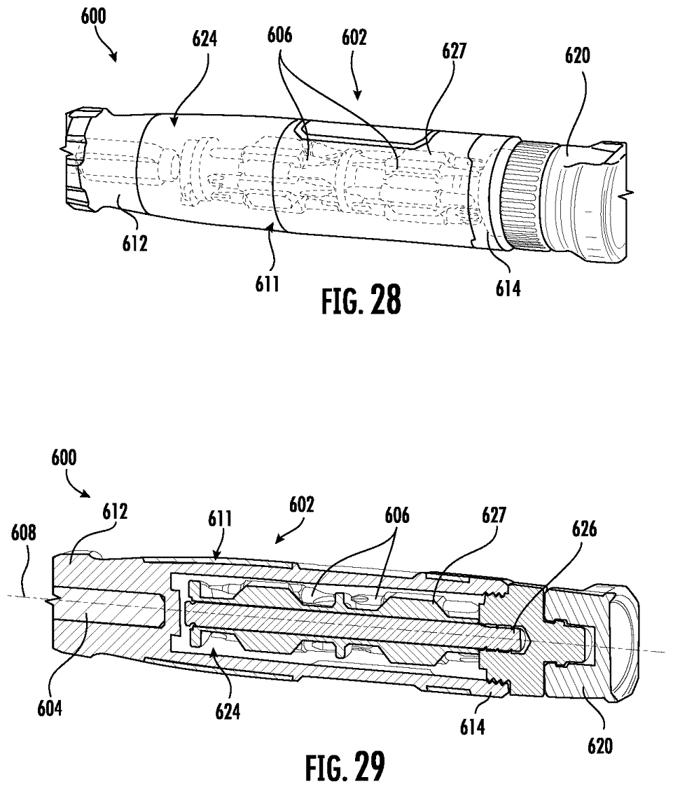

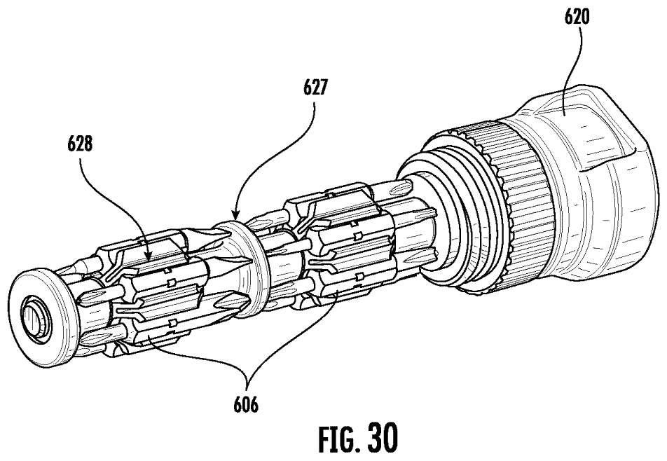

Referring to FIGS. 26-30, a driving tool, such as screwdriver 600 is shown. Screwdriver 600 is believed to provide benefits over other screwdrivers such as being more compact because engagement bits, such as screwdriver bits 606, are stored within a handle 602 of screwdriver 600.

Screwdriver 600 includes handle 602 and a shaft 604. Handle 602 is centered on and extends along a longitudinal axis 608. Shaft 604 is coupled to a first end 612 of handle 602.

Handle 602 has a body 610 with an outer surface 611 that defines a cavity 624. Outer surface 611 circumferentially surrounds cavity 624 with respect to longitudinal axis 608. Cavity 624 is configured to store a plurality of bits 606.

An end cap 620 is removably coupled to a second end 614 of handle 602 opposite from shaft 604 with respect to longitudinal axis 608. When coupled to second end 614, end cap 620 extends into cavity 624. End cap 620 includes a shank 626 and a carrier 627 coupled to shank 626. Screwdriver bits 606 are configured to be mounted on carrier 627 and stored within cavity 624, when bits 606 are not in use. Carrier 627 includes wings 628 configured to engage bits 606. As shown, bits 606 are double-ended screwdriver bits, and wings 628 engage a middle portion of bits 606 to retain bits 606 on carrier 627.

To access bits 606, a user can fully remove end cap 620 from handle 602. The user may then select the desired bit 606 from carrier 627 and mount the selected bit 606 on shaft 604.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A driving tool, comprising:
a handle;
a shaft centered on and extending along a longitudinal axis, the shaft comprising:
a mounting end;
a second end opposite the mounting end, the second end coupled to a first end of the handle; and
a flange extending away from an external surface of the shaft between the mounting end and the second end, the flange comprising:
a first step extending circumferentially around the longitudinal axis, the first step defining a first radius; and
a second step extending circumferentially around the longitudinal axis, the second step defining a second radius different from the first radius; and
a first socket comprising a first engagement end and a second engagement end, wherein the first engagement end of the first socket is configured to engage with the first step such that the first step defines a first effective depth of the first socket.

2. The driving tool of claim 1, and wherein the second engagement end of the first socket is configured to engage with the second step such that the second step defines a second effective depth of the first socket.

3. The driving tool of claim 1, wherein the first radius is less than the second radius.

4. The driving tool of claim 1, wherein the flange further comprises a third step extending circumferentially around the longitudinal axis and defining a third radius different from the first radius and the second radius.

5. The driving tool of claim 4, wherein the second step is positioned between the first step and the third step.

6. The driving tool of claim 4, wherein the third radius is greater than the first radius and the second radius.

7. The driving tool of claim 1, wherein the flange is spaced a first distance from the mounting end that is less than a second distance the flange is spaced from the second end of the shaft.

8. The driving tool of claim 1, wherein the flange is from a single contiguous, continuous piece of material with the shaft.

9. A driving tool, comprising:
a handle centered on and extending along a longitudinal axis, the handle comprising a first end and a second end opposite the first end along the longitudinal axis;
a shaft removably coupled to the first end of the handle, the shaft centered on and extending along the longitudinal axis, the shaft comprising:
a mounting end;
a second end opposite the mounting end along the longitudinal axis, the second end of the shaft coupled to the first end of the handle;
a first step positioned along the shaft between the mounting end and the second end of the shaft, the first step extending circumferentially around the longitudinal axis; and
a second step extending circumferentially around the longitudinal axis, wherein the first step extends away from a top surface of the second step towards the mounting end; and
a first socket comprising a first engagement end defining a first circumference, the first engagement end of the first socket configured to engage with the first step such that the first step defines a first effective depth of the first socket; and
a second socket comprising a second engagement end defining a second circumference greater than the first circumference, the second engagement end of the second socket configured to engage with the second step such that the second step defines a second effective depth of the second socket.

10. The driving tool of claim 9, further comprising a third socket, and wherein the shaft further comprises a third step extending circumferentially around the longitudinal axis, wherein the second step extends away from a top surface of the third step towards the mounting end, and wherein the third socket is configured to engage with the third step.

11. The driving tool of claim 9, wherein the shaft further comprises a plurality of recesses formed along an external surface of the shaft between the second step and the second end of the shaft.

12. The driving tool of claim 11, wherein the first socket is mounted on a first recess of the plurality of recesses, and wherein the second socket is mounted on a second recess of the plurality of recesses.

13. The driving tool of claim 12, wherein the first socket comprises a projection, and wherein the projection engages with the first recess to retain the first socket along the shaft.

14. A driving tool, comprising:
a handle centered on and extending along a longitudinal axis, the handle comprising:
a first end;
a second end opposite the first end along the longitudinal axis; and
a body extending between the first end and the second end, the body defining a cavity;
wherein an outer surface of the body circumferentially surrounded the cavity with respect to the longitudinal axis;
an end cap configured to removably couple to the second end of the handle, the end cap comprising a base and a shank extending away from the base; and
an engagement bit comprising a central opening, the engagement bit mounted on the shank, wherein, when the end cap is coupled to the second end of the handle, the shank extends away from the base within the cavity and towards the first end of the handle, and the engagement bit is retained within the cavity along the shank.

15. The driving tool of claim 14, wherein when the end cap is coupled to the second end of the handle, the shank is centered on and extends along the longitudinal axis.

16. The driving tool of claim 14, wherein the shank comprises a receiving end and an attachment end opposite the receiving end, wherein the attachment end is removably coupled to the base, and wherein the engagement bit is mounted on the shank between the receiving end and the attachment end.

17. The driving tool of claim 14, wherein an inner surface of the engagement bit interfaces with an external surface of the shank when the engagement bit is mounted on the shank.

18. The driving tool of claim 14, wherein the shank comprises a recess and the engagement bit comprises a projection extending away from an inner surface of the engagement bit, and wherein, when the engagement bit is mounted on the shank, the projection engages with the recess to retain the engagement bit along the shank.

19. The driving tool of claim 14, wherein the engagement bit is a socket.

20. The driving tool of claim 14, wherein the cavity is centered on and extends along the longitudinal axis between the first end and the second end of the handle.
